(19) United States
(12) Patent Application Publication
(10) Pub. No.: US 2023/0404321 A1
(43) Pub. Date: Dec. 21, 2023

(54) Methods and systems for facilitating autonomous cooking of meals using a smart cooker

(71) Applicant: Ragy Khairy Khalil Shaaban, Southampton (GB)

(72) Inventor: Ragy Khairy Khalil Shaaban, Southampton (GB)

(21) Appl. No.: 18/206,165

(22) Filed: Jun. 6, 2023

Related U.S. Application Data
(60) Provisional application No. 63/352,272, filed on Jun. 15, 2022.

(51) Int. Cl. A47J 36/32; A47J 27/00; A47J 36/06; A47J 47/01; A47J 43/046; A47J 43/07; B65D 81/32

(52) U.S. Cl. CPC A47J 36/321; A47J 27/004; A47J 36/06; A47J 47/01; A47J 43/046; A47J 43/0716; B65D 81/32; B65D 2221/00

(57) ABSTRACT

The present invention is about an automatic cooking system for autonomous cooking using a portable smart cooker. The smart cooker undertakes such autonomous cooking through appropriate pressure control and using a meal pod that comprises of multi-dispenser units for automated dispensing of ingredients, following the instructions in a digital recipe. The smart cooker allows user controls through touch-screen digital interface along with app-controlled applications.

### CROSS-REFERENCE TO RELATED APPLICATION

This application claims the benefit of U.S. Provisional Patent Application No. 63/352,272, titled “METHODS AND SYSTEMS FOR FACILITATING AUTONOMOUSLY COOKING MEALS USING A MEALTEC SMART COOKER”, filed on 15 Jun. 2022, which is incorporated by reference herein in its entirety.

### FIELD OF THE INVENTION

The present invention relates to an automatic cooking system which is portable, having automatic ingredient dispenser and compatible modules, adapting capabilities, and is user friendly in usage and controlling.

### BACKGROUND OF THE INVENTION

The field equipment for preparing or serving food is technologically important to several industries, business organizations, and/or individuals.

Existing techniques for facilitating autonomously cooking meals are deficient with regard to several aspects. For instance, current technologies cook all ingredients at the same time and at the same temperature thus substantially limiting its flavor and nutrient capability. Further, there is no stirring or mixing of ingredients which limits the induced tastes in the kind of meals produced. Furthermore, current technologies store the ingredients in several small containers, making these unsuitable for meeting mass demand.

Therefore, there is a need for improved methods and systems for facilitating autonomously cooking meals using a smart cooker that may overcome one or more of the above-mentioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

An aspect of the present invention is to provide a system configured for facilitating autonomous cooking using a smart cooker.

A further aspect of the present invention is to provide a smart cooker which performs all functions autonomously and does not require a user's attendance or intervention in the cooking process.

A still further aspect of the invention is to provide a smart cooker which is solid and a compact kitchen robot working in unison that minimizes the space occupied on the kitchen top.

Another aspect of the invention is to provide an automatic portable cooker having automated multi-dispenser units for efficient dispensing of ingredients.

A still further aspect of the invention is to provide a smart cooking system having a touch-screen display, allowing the user to request the preparation of a meal of their choice in a discrete manner.

Another aspect of the invention is to provide a smart cooker which is IoT enabled so that can be controlled by means of a mobile application.

A still further aspect of the invention is to provide a smart cooker in which the temperature may be controlled by means of a heating element.

Another aspect of the invention is to provide a single, multi-compartment container (Meal Pod) to store ingredients separately, to be installed on the smart cooker.

Further aspect of the invention is to provide a water tank fixed at the back for storing and dispensing water in the smart cooker pot.

Still further aspect of the invention is to provide appropriate pressure control to accelerate the cooking process and shorten the cooking time consequently.

Another aspect of the invention is to provide a smart cooker which is portable fully automatic cooking system, highly efficient and effective in cooking thereby instituting greater level of efficiency. Such efficiency is achieved only when a systematic structuring of the system is performed from initial design point for which command and control architecture has been designed.

Still another aspect of the invention is to provide a smart cooker which has a digital User Interface and software program to control the machine which is also inclusive of but not limited to using of various computation devices such as but not limited to desktop, laptop, tablets or smart phones.

Further aspects of the invention enable the application to fetches a recipe file/data as selected by the user, performs required operations on it as per the recipe defined, interprets it, executes it on the machine, apart from executing the command(s) successfully.

It is a further aspect of the invention to provide an online platform for facilitating autonomously cooking meals using the smart cooker which may be hosted on a centralized server, such as, for example, a cloud computing service wherein the centralized server may communicate with other network entities, such as, for example, a mobile device over a communication network, as the internet.

An aspect of the invention is to provide a programming model to convert recipes to software programs (digital recipes), to be used in cooking ingredients autonomously.

Another aspect of the invention is to provide a software platform to develop, store, interpret and execute digital recipes.

Further aspect of the invention is to incorporate into the smart cooker, an online system of storing, organizing, ordering and scheduling of meal kits.

Yet another aspect of the invention is to provide for a portable fully automatic cooking, system through the smart cooker having embodied machine controller/microcontroller(s) unit which communicates with the User Interface Device and which controls all the hardware, electronics, other dedicated slave microcontrollers, integrated circuits, sensors, motors etc. based on the command(s) received.

A still further aspect of the invention is to provide controlling adaptability wherein the system/machine can be controlled by desktops, laptops, tablets, smart phones, and other smart devices including but not limited to smart speakers, smart watches and smart fridges.

Another aspect of the invention is to have a high level of adaptability that provides user an extra edge over the usage of machine to its optimum level.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an exploded view of the smart cooker represented for facilitating autonomous cooking meals, in accordance with some embodiments.

FIG. 2 is a partial front top perspective view of the smart cooker representing the cooking pot and the motorised stirrer for facilitating autonomous cooking meals, in accordance with some embodiments.

FIG. 3 illustrates a dismantled view of the smart cooker showing two housings of the smart cooker, wherein the first housing contains the meal pod, covered by the multi-dispensing motorized lid, the second housing contains the internal pot, associated with the smart cooker for facilitating autonomous cooking meals, in accordance with some embodiments.

FIG. 4 illustrates a dismantled view of the smart cooker showing the various components of the smart cooker of the present invention comprising the internal cooking pot, the main meal pod, a permanent multi-compartmented ingredient dispenser, a disposable meal pod, a disposable multi-compartmented ingredient dispenser and the motorized lid.

FIG. 5 is an illustration of an online platform consistent with various embodiments of the present disclosure.

FIG. 6 is a block diagram of a system configured for facilitating autonomously cooking meals using a smart cooker, in accordance with some embodiments.

FIG. 7 is a block diagram of a computing device for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating autonomous cooking meals using a smart cooker, embodiments of the present disclosure are not limited to use only in this context.

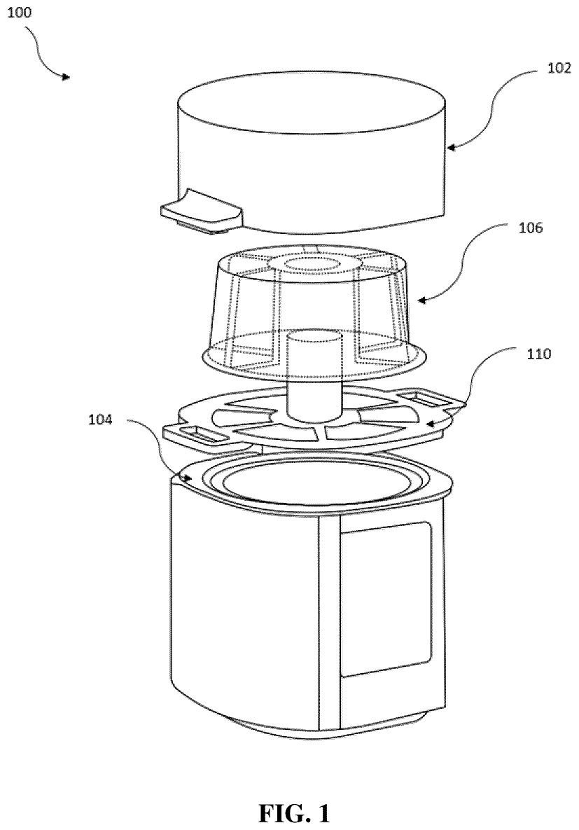

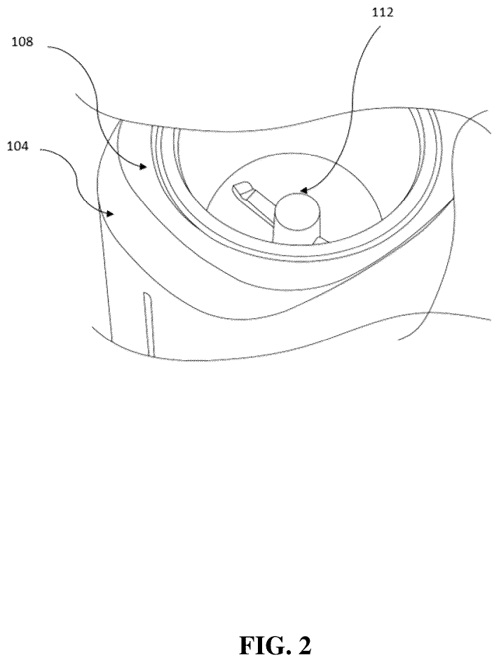

Referring now to FIGS. 1 through 4, a smart cooker 100 for facilitating autonomous cooking meals is disclosed comprising a first housing 102 and a second housing 104 wherein, the first housing 102 is for inserting a meal pod 106, a multi-compartment ingredient storage container, a removable cooking pot 108 with a built-in motorized stirrer 112, a multi-dispensing motorized lid 110 that may be placed on the Meal Pod 106 for dispensing ingredients from the Meal Pod 106 to the cooking pot in the smart cooker following a used recipe.

The Meal Pod 106 may be a multi-compartment container which may store pre-portioned, pre-cut, fresh ingredients. The Meal Pod 106 may be inserted in the first housing 102 of smart cooker 100 and the desired food is cooked following the instructions in a digital recipe, wherein the raw or cooked ingredients for the recipe are pre-portioned and pre-cut, and stored in the multi-compartment container which are dispensed in the cooking pot of the smart cooker upon initiation of the cooking process by activating the start button on the digital screen of the smart cooker. The smart cooker 100 dispenses and cooks the ingredients from the Meal Pod 106, following instructions in a digital recipe which is a recipe for preparing a food item.

In some embodiments the meal pod 106 is permanent and non-disposable made of thick, hard plastic. It may be filled by the user with pre-cut, fresh ingredients. It can be washed and used more than once.

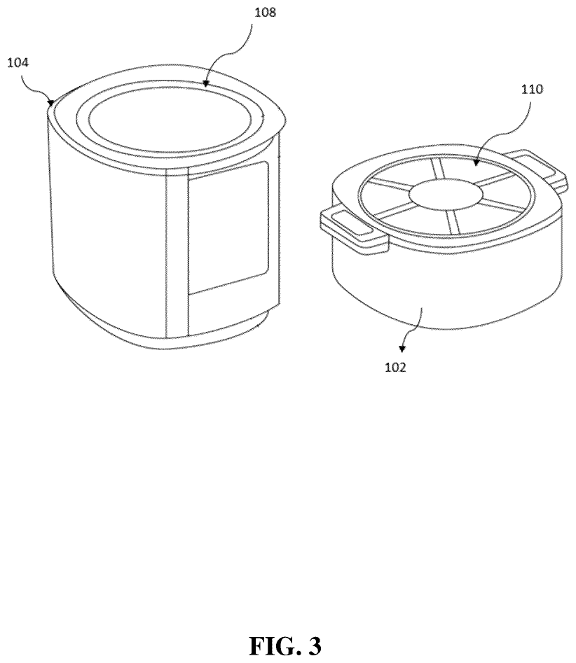

FIG. 3 represents the partly assembled components of the smart cooker of the present invention including first housing 102 with the compartmented meal pod 106 with the motorized lid 110 inserted and the second housing 104 with the inserted removable cooking pot 108.

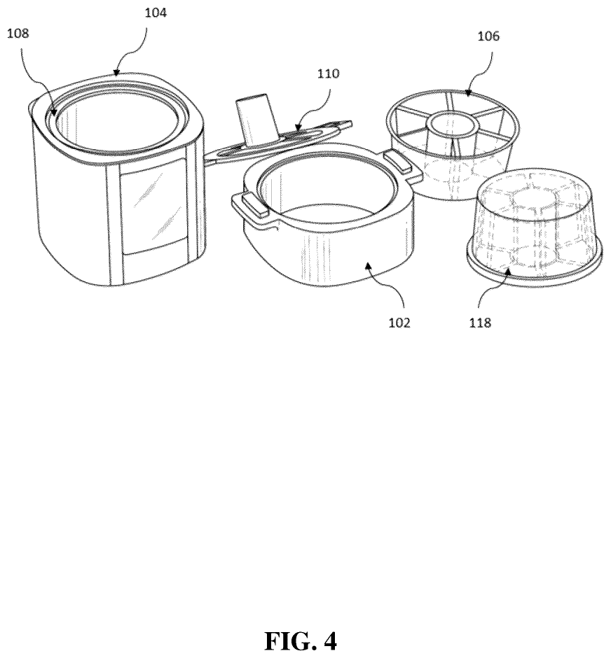

FIG. 4 represents the disassembled components of the smart cooker of the present invention including first housing 102 separated and segregated from the compartmented meal pod 106. The motorized lid 110 is also depicted as separated from the meal pod 106 and the second housing 104 with the inserted removable cooking pot 108 is also illustrated. Also depicted is the disposable meal pod 118 of the present invention.

In an embodiment of the present invention, the digital recipe is effectuated through a digital memory that stores instructions along with a processor that executes the instructions to perform operations in churning out a typical recipe.

In an embodiment, a digital recipe including digital content is obtained by utilizing a natural language processing engine that allows digital content for keywords to be identified for at least one recipe stage of the digital recipe. Thereupon each recipe stage of the at least one recipe stage is identified that corresponds to a cooking stage. Further, a key ingredient in each recipe stage that corresponds to the cooking stage is identified, wherein the key ingredient is an ingredient having a critical effect on a cooking time for the cooking stage. Then at least one recipe stage is determined that corresponds to the cooking stage thereby correlating to an existing machine instruction stored in the memory, wherein such determination is based in part on the key ingredient. Thereby, the at least one recipe stage corresponding to the cooking stage is substituted via the existing machine instruction and correlates with the existing machine instruction with enhanced content so as to enhance the digital recipe. Finally, reformatting the digital recipe into a digital file including a machine instruction set for enabling the device to facilitate performance of the at least one recipe stage.

In an embodiment of the invention, the above mentioned process in effectuating the digital engine incorporated recipe involves at least one cooking command may actuate at least one of the actuators comprised in the smart cooker at the specified instant of time. A first actuator of the at least one actuator may be configured for dispensing the ingredients in the compartments in the meal pod based on the at least one recipe data. The second actuator of the, at least one actuator may be configured for stirring the ingredients at a speed by the motorized stirrer based on the at least one recipe data. Whereas a third actuator of the, at least one actuator may be configured for controlling the heating effect provided by the heating element based on the at least one recipe data.

In some embodiments, the smart cooker may accept a disposable meal pod 118, the material of which includes soft, thin plastic. It is delivered to the customer's home pre-filled with ingredients, following a meal subscription plan. The user may also buy it pre-filled from grocery stores. The disposable meal-pod is used only once and then disposed by the user.

A power source configured for storing electricity powers the electric-powered, heating element of the smart cooker which is responsible for heating the cooking pot, of the smart cooker.

In some embodiments, the power source of the smart cooker is configured for storing power for providing electric power to the minicomputer and the hardware components, at times of need.

The smart cooker of the present invention may include integrated temperature sensors.

Also included in the smart cooker is a digital display, displaying the status of the smart cooker and the progress of the cooking process.

The hardware components of the smart cooker may further include multiple actuators, each controlling the operation of at least one of stirrer, the multi-dispensing lid or the heating element of the smart cooker.

The smart cooker also has a tank fixed at the back which can be filled in by the user with water in the same manner as a Nespresso machine water tank. The cooker dispenses water from the tank in the cooking pot autonomously when needed, following each recipe instructions.

The hardware components of the smart cooker may further include the motorized stirrer 112, the heating element and the motorized multi dispensing lid 110 which, including the actuators may be controlled by a software/firmware program running on an integrated minicomputer comprised in the smart cooker. The minicomputer may include a processor, a communicator, and a data storage device.

Further in some embodiments of the present invention, the smart cooker also has a provision for incorporation of an alternative stirring mechanism in which the cooking pot acts as rotating drum that rotates as a whole to stir the ingredients within, thereby replacing the motorized stirrer part.

In further embodiments, the software/firmware program also performs the function of reading the temperature sensor data, controlling the heating element, the motorized stirrer, and the motorized multi-dispending lid, by means of a controller, wherein, the information is sent to a digital display comprised in the smart cooker. The smart cooker may be an IoT-connected device that can be controlled via a mobile application.

In some embodiments, the smart cooker may also join a smart network and communicate with other smart IoT devices.

Further embodiments of the invention disclose a system which includes a smart cooker which autonomously cooks meals from scratch using a Meal Pod 106 which may be a multi-compartment container storing pre-portioned, pre-cut, fresh ingredients. The Meal Pod 106 may be inserted in the first housing 102 of the smart cooker 100 and the cooking initiated by activating the start button of the smart cooker 100 the food being cooked by dispensing the ingredients from the multi-compartmented container 106 and cooking the ingredients in the removable internal cooking pot 108 inserted in the second housing 104 of the smart cooker 100, following instructions in a digital recipe.

In further embodiments, the smart cooker 100 introduces a disposable Meal Pod 118 multi-compartment ingredient storage unit that may be bought as part of a meal-kit subscription or on-demand from grocery stores. Further, the smart cooker cooks a variety of meal types covering hundreds of recipes for soups, stews, entrees, rice, risotto, pasta, and desserts.

According to some aspects, a system configured for facilitating autonomously cooking meals using a smart cooker of the present invention is disclosed. Accordingly, the system may include a communication device configured for receiving a request from at least one input device. The system includes at least one input device which may be at least one user device comprising a smart phone, a tablet, a laptop, and so on. The user device may be associated with at least one user comprising an individual, an institution, and an organization that may want to autonomously cook at least one meal.

In some embodiments, the input device may include a touch screen display comprised in the smart cooker. The activation of the smart cooker involves, sending a request by at least one user who may want to prepare the at least one meal. The associated communication device may be configured for transmitting at least one cooking command to the smart cooker and for receiving at least one sensor data comprised in the smart cooker.

Further, in some embodiments, the communication device may be configured for transmitting the cooking status to at least one of a display device comprised in the smart cooker and the at least one user device. The display device may be configured for presenting the cooking status.

The system also includes a processing device communicatively coupled with the communication device.

The processing device of the system may be configured for analysing at least one recipe data as well as for generating the at least one cooking command based on the analysing. The processing device may also be configured for analysing the at least one sensor data for generating a cooking status. The cooking status may indicate a status corresponding to a cooking process of the at least one meal. It may also indicate if the at least one meal is fully cooked or not. Also, the generating of the at least one cooking command may be based on the cooking status.

The sensors may include at least one of thermal sensor, an image sensor or a watch, etc.

The system may also include a storage device communicatively coupled with the processing device wherein, the storage device may be configured for retrieving the at least one recipe data associated with at least one recipe based on the request.

In further embodiments, a method for facilitating autonomously cooking meals using the smart cooker is disclosed. Accordingly, the method may include placing pre-portioned and cut fresh ingredients in the compartments of the Meal Pod. It further includes covering the Meal Pod with the multi-dispensing, motorized lid and then placing it upside down on the cooking pot. The method may further include selecting a recipe by a user and the user pressing a Start button to start the cooking process. Following the recipe, the method may include the cooker setting a temperature in the cooking pot by controlling the heating element. Further, the method may include the cooker dispensing each of the ingredients from the Meal Pod compartments, at the specified time as per the recipe. Further, the method may include the machine activating the motorized stirrer when needed, as directed by the recipe. Further, after all the ingredients have been dispensed and the cooking time has passed, the outcome is a freshly cooked meal ready for serving.

Towards control of the cooking process, appropriate pressure control to accelerate the cooking process and shorten the cooking time consequently is deployed by the said smart cooker. Such pressure control can be applied electronically and autonomously, within the recipe steps to shorten the cooking times.

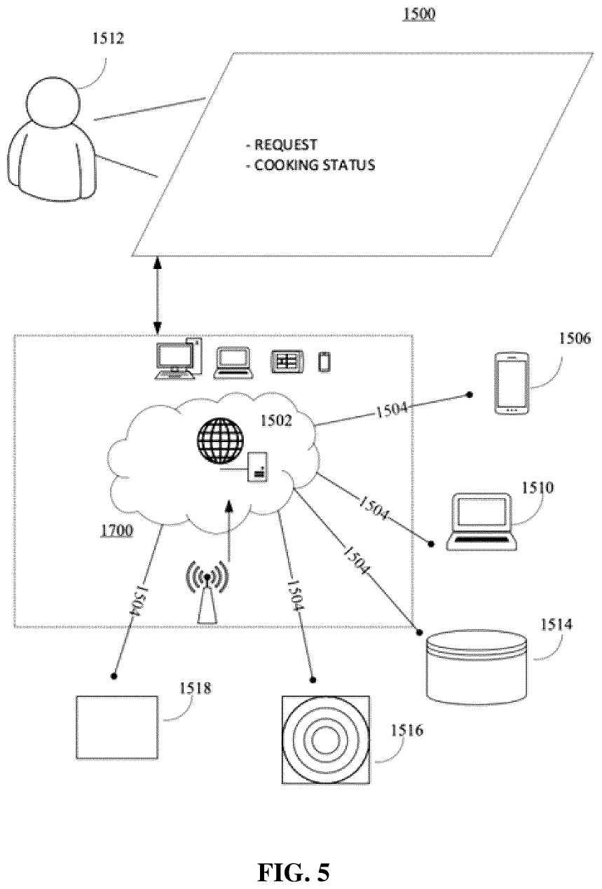

FIG. 5 is an illustration of an online platform 1500 consistent with various embodiments of the present disclosure. By way of non-limiting example, the online platform 1500 for facilitating autonomously cooking meals using the smart cooker may be hosted on a centralized server 1502, such as, for example, a cloud computing service. The centralized server 1502 may communicate with other network entities, such as, for example, a mobile device 1506 (such as a smartphone, a laptop, a tablet computer, etc.), other electronic devices 1510 (such as desktop computers, server computers, etc.), databases 1514, sensors 1516, actuators (not shown), and a device 1518 (such as the MealTec smart cooker) over a communication network 1504, such as, but not limited to, the Internet. Further, users of the online platform 1500 may include relevant parties such as, but not limited to, end-users, service providers, chefs, and administrators. Accordingly, in some instances, electronic devices operated by the one or more relevant parties may be in communication with the online platform 1500.

A user 1512, such as the one or more relevant parties, may access the online platform 1500 through a web-based software application or browser. The web-based software application may be embodied as, for example, but not be limited to, a website, a web application, a desktop application, and a mobile application compatible with a computing device 1700.

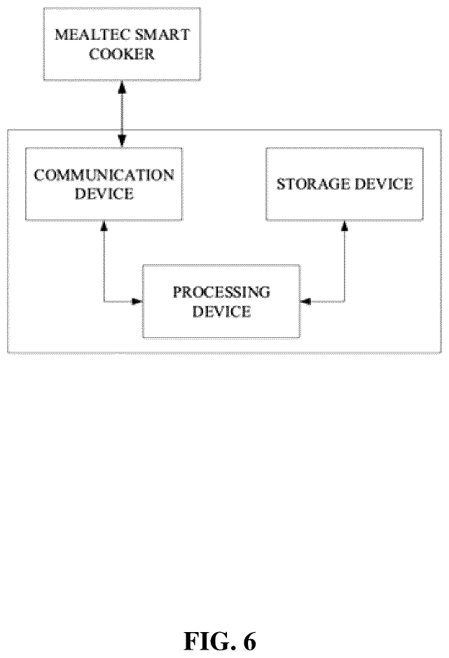

FIG. 6 is a block diagram of a system configured for facilitating autonomously cooking meals using a smart cooker, in accordance with some embodiments. Accordingly, the system may include a communication device configured for receiving a request from at least one input device. Further, the at least one input device may include at least one user device comprising a smartphone, a tablet, a laptop, and so on. Further, the at least one user device may be associated with at least one user comprising an individual, an institution, and an organization that may want to autonomously cook at least one meal. Further, the at least one input device may include a touchscreen display comprised in the smart cooker. Further, the request may indicate that the at least one user may want to prepare the at least one meal. Further, the communication device may be configured for transmitting at least one cooking command to the smart cooker.

Further, the system may include a processing device communicatively coupled with the communication device. Further, the processing device may be configured for analyzing at least one recipe data. Further, the processing device may be configured for generating the at least one cooking command based on the analyzing.

Further, the system may include a storage device communicatively coupled with the processing device. Further, the storage device may be configured for retrieving the at least one recipe data associated with at least one recipe based on the request.

Further, in some embodiments, the communication device may be configured for transmitting the at least one recipe data to the at least one user device. Further, the communication device may be configured for receiving at least one recipe modification corresponding to the at least one recipe data from the at least one user device.

Further, the processing device may be configured for updating the at least one recipe data to the at least one user device. Further, the processing device may be configured for generating at least one updated recipe data. Further, the generating of the at least one cooking command may be based on the at least one updated recipe data.

In further embodiments, the smart cooker may include a communicator (such as the communication device), a processor (such as the processing device), and a data storage device (such as the storage device). Further, the processing device may be communicatively with the communicator and the data storage device.

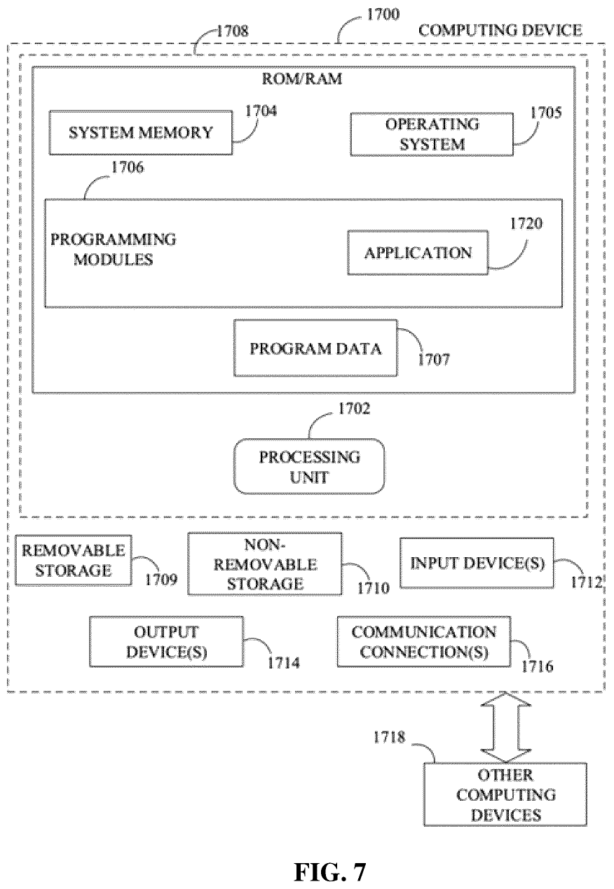

With reference to FIG. 7, a system consistent with an embodiment of the disclosure may include a computing device or cloud service, such as computing device 1700. In a basic configuration, computing device 1700 may include at least one processing unit 1702 and a system memory 1704. Depending on the configuration and type of computing device, system memory 1704 may comprise, but is not limited to, volatile (e.g. random-access memory (RAM)), non-volatile (e.g. read-only memory (ROM)), flash memory, or any combination. System memory 1704 may include operating system 1705, one or more programming modules 1706, and may include a program data 1707. Operating system 1705, for example, may be suitable for controlling computing device 1700's operation. In one embodiment, programming modules 1706 may include image-processing module, machine learning module and/or image classifying module. Furthermore, embodiments of the disclosure may be practiced in conjunction with a graphics library, other operating systems, or any other application program and is not limited to any particular application or system. This basic configuration is illustrated in FIG. 7 by those components within a dashed line 1708.

Computing device 1700 may have additional features or functionality. For example, computing device 1700 may also include additional data storage devices (removable and/or non-removable) such as, for example, magnetic disks, optical disks, or tape. Such additional storage is illustrated in FIG. 7 by a removable storage 1709 and a non-removable storage 1710. Computer storage media may include volatile and non-volatile, removable and non-removable media implemented in any method or technology for storage of information, such as computer-readable instructions, data structures, program modules, or other data. System memory 1704, removable storage 1709, and non-removable storage 1710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1700. Any such computer storage media may be part of device 1700. Computing device 1700 may also have input device(s) 1712 such as a keyboard, a mouse, a pen, a sound input device, a touch input device, a location sensor, a camera, a biometric sensor, etc. Output device(s) 1714 such as a display, speakers, a printer, etc. may also be included. The aforementioned devices are examples and others may be used.

Computing device 1700 may also contain a communication connection 1716 that may allow device 1700 to communicate with other computing devices 1718, such as over a network in a distributed computing environment, for example, an intranet or the Internet. Communication connection 1716 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 1704, including operating system 1705. While executing on processing unit 1702, programming modules 1706 (e.g., application 1720 such as a media player) may perform processes including, for example, one or more stages of methods, algorithms, systems, applications, servers, databases as described above. The aforementioned process is an example, and processing unit 1702 may perform other processes. Other programming modules that may be used in accordance with embodiments of the present disclosure may include sound encoding/decoding applications, machine learning application, acoustic classifiers, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The working of the smart cooker can be summarised as under:
1. The raw or cooked ingredients required for the recipe are pre-proportioned, pre-cut and stored in the multi compartmented meal pod container.
2. The meal pod is covered with the multi-dispensing, motorized lid and overturned along with the lid over the cooking pot of the meal-pod.
3. The user makes a request for a recipe which can be selected from the uploaded or inbuilt recipes of the device or the user may define a custom made recipe by means of an input device which includes a touch screen display of the smart cooker. The smart cooker may also identify the recipe autonomously on scanning of the QR code by a typical user.
4. A storage device communicatively coupled with the processing device may be configured for retrieving at least one recipe data associated with at least one recipe based on the request.
5. The request received by the communication device from the input device of the smart cooker is processed and analysed by the processor.
6. The processor is configured for generating the cooking command based on the recipe data.
7. Upon receiving the cooking command, the controller performs the following functions:
a) sets the cooking temperature of the heating element based on the recipe to be cooked and maintains and varies the temperature depending upon the requirement of the recipe, which is further aided by the temperature sensors, which communicates the temperature changes during the cooking process.
b) activates the actuator of meal pod motorised lid for dispensing the ingredients at a specified time as is required by the recipe.
c) it further activates the actuator of the stirrer of the meal-pod when required and directed by the recipe.
d) the meal is cooked according to the recipe and the cooked meal is ready after an elapsed time.

The communication device which is configured for transmitting the cooking status to the display unit/device of the smart cooker and the user device, transmits it and the display device displays the cooking status.

The smart cooker updates any modifications in the recipe data from the user's device and effectuate the same.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

1. A smart cooker for autonomously cooking meals, the smart cooker comprising:
a meal pod with multi-compartment ingredient storage container;
a removable cooking pot with a built in motorized stirrer;
a multi-dispensing motorized lid;
a heating element;
a water tank;
at least one actuator;
at least one sensor;
a power source;
a digital touchscreen display unit;
a storage device;
a communication device configured for receiving at least one sensor data;
a processor for analysing at least one sensor data;
at least one user device; and
at least one input device;
wherein, during operation of the said smart cooker, the temperature of the heating element, the speed and time span of the said motorised stirrer, and the motorised multi-dispensing lid of the said meal pod is controlled based on the recipe data;
wherein, the status of the cooking is sent to the user device and the said digital display unit of the smart cooker.

2. The smart cooker of claim 1, wherein the said actuator is three in number.

3. The smart cooker of claim 2, wherein a first actuator is configured for dispensing the ingredients in the compartment, a second actuator is configured for stirring the ingredients and the third actuator is configured for controlling the heating effect.

4. The smart cooker of claim 1, wherein, the said water tank dispenses water in the cooking pot autonomously, when needed, following each recipe instruction.

5. The smart cooker of claim 1, wherein, the said cooking pot, has an alternative stirring functionality by transforming as a rotating drum, simulating its stirring mechanism.

6. A smart cooker of claim 1, wherein the said meal pod is disposable.

7. A smart cooker of claim 2, wherein the said disposable meal pod is of soft, thin plastic.

8. A smart cooker of claim 1, wherein the power source for the operation of the smart cooker is electrical energy.

9. A smart cooker of claim 1, wherein the said sensors are at least one of thermal sensor, an image sensor or a watch.

10. The method for facilitating autonomous cooking means by means of smart cooker comprises:
Pre-cutting and storing the raw or cooked ingredients required for the recipe in the multi compartmented meal pod container;
Covering the meal pod with the multi-dispensing, motorized lid and overturning the meal pod along with the said lid over the cooking pot with the motorized stirrer;
Requesting by the user makes for a recipe selected from the uploaded or inbuilt recipes of the device;
Retrieving at least one recipe data associated with at least one recipe based on the request by the device;
processing and analysing the request received and generating the cooking command based on the recipe by the device;
Setting the cooking temperature of the heating element based on the recipe to be cooked and maintaining the temperature depending upon the requirement of the recipe;
activating the stirrer of the meal-pod when required and directed by the recipe;
activating the meal pod motorised lid for dispensing the ingredients at a specified time as is required by the recipe;
transmitting the cooking status to the display unit/device of the smart cooker and the user device; and
displaying the cooking status on the display unit of the smart cooker and the user device.

11. A system for facilitating autonomous cooking of meals by means of a smart cooker, the system comprising:
a smart cooker comprising a meal pod with multi-compartment ingredient storage container; removable cooking pot with a built-in motorized stirrer;
a multi-dispensing motorized lid;
at least one actuator;
a water tank; and
a minicomputer integrated with the said smart cooker comprising a processor, a communicator, a storage device, at least one input device, at least one user device; and
a non-transitory computer readable medium.

12. The system of claim 11, wherein, during operation,
configuring the communication device for receiving a request from at least one input device of the user for preparation of the meal;
communicatively coupling the processing device with the communication device, and configuring for analyzing the request received by the communication device and transmitting the recipe data associated with the request to the smart cooker;
generating the cooking command, by the processor based on the request;
analyzing the at least one sensor data by the processor and transmitting it to the smart cooker for activating the heating element, the actuators of the said motorized lid, and the motorized stirrer based on the request.

13. The system of claim 12, wherein, the said system further comprises a pressure control for controlling the cooking process, for accelerating the cooking process and shortening the cooking time.

14. The system of claim 13, wherein, the said pressure control is applied electronically and autonomously.

15. The system of claim 11, wherein the said communication device is configured for receiving at least one recipe modification corresponding to at least one recipe data from at least one user device.

16. The system of claim 11, wherein the said system can be activated and autonomous cooking facilitated by means of an online platform hosted on a centralized server, communicating with other network entities.

17. The system of claim 11, wherein the said centralized server is a cloud computing service.

18. The system of claim 11, wherein the said system is adaptable to be controlled by desktops, laptops, tablets and smart phones.
